(19) United States
(12) Patent Application Publication
(10) Pub. No.: US 2015/0234069 A1
(43) Pub. Date: Aug. 20, 2015

(54) System and Method for Quantifying Vug Porosity

(71) Applicant: Schlumberger Technology Corporation, Sugar land, TX (US)

(72) Inventors: Terizhandur S. Ramakrishnan, Boxborough, MA (US); Nadege Bize-Forest, Creancy (FR); Rodolfo Oliveira, Rio de Janeiro (BR); Flora Marques, Paris (FR); Austin Boyd, Rio de Janeiro (BR); Emmanuel Bize, Longvic (FR)

(21) Appl. No.: 14/623,409

(22) Filed: Feb. 16, 2015

Related U.S. Application Data
(60) Provisional application No. 61/940,006, filed on Feb. 14, 2014.

(51) Int. Cl. G01V 1/30; E21B 49/00; G01V 1/40

(52) U.S. Cl. CPC G01V 1/306; G01V 1/40; E21B 49/00

(57) ABSTRACT

Methods and systems acquiring acoustic data utilizing a downhole tool conveyed within a borehole extending into a subterranean formation. The downhole tool is in communication with surface equipment disposed at a wellsite surface from which the borehole extends. Techniques involve operating at least one of the downhole tool and the surface equipment to generate a histogram based on the acoustic data, normalizing the histogram, and calculating a vug index based on the normalized histogram and based on a threshold of the normalized histogram. A vug porosity quantity may be determined based on the calculated vug index.

### CROSS-REFERENCE TO RELATED APPLICATIONS

This application claims the benefit of and priority to U.S. Provisional Application No. 61/940,006, entitled “System and Method for Quantifying Vug Porosity,” filed Feb. 14, 2014.

### BACKGROUND OF THE DISCLOSURE

This disclosure relates generally to downhole tools and more specifically to quantifying vug porosity from ultrasonic borehole image logs.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions.

Before producing hydrocarbons from the reservoir, properties of the reservoir may first be analyzed. One property that is often analyzed includes the porosity of the reservoir. Porosity may include the volume of the pore space expressed as a percent of the total volume of the rock mass, or that volume within the rock formation that can contain fluids. Accurately quantifying the porosity of a reservoir volume may be used for production planning and ultimate hydrocarbon recovery, i.e., the percentage of total hydrocarbons producible from the reservoir over its entire lifespan.

Many productive carbonates show complex porosity systems with widely varying proportions of different types of porosity measurements. For instance, primary porosity may be from the matrix and may be associated with the host material. Secondary porosity may be from vugs and open fractures in the formation. Secondary porosity in carbonate rocks, primarily related to vugs and fractures, impacts fluid flow and recovery efficiency in subterranean reservoirs. The porosity system may be complex in carbonates where the distribution of primary and secondary porosity varies from facies-to-facies at different scales. Rapid changes in carbonate depositional environments may create different facies within a short vertical scale. The subsequent diagenesis processes, such as dissolution, cementation, and dolomitization, may alter each facies differently. In carbonate rocks, the diagenesis process may create vugs, which are cavities in the rock that are visible to the unaided eye. The vugs may be categorized as isolated vugs or connected (touching) vugs. Tectonic stress may also superimpose fracture networks to the subterranean formation. For the pore spaces connected to fractures, solution-enhanced bedding planes and vugs (vug-to-vug) may enhance the fluid flow, and are well related to increased oil recovery rates. On the contrary, the porosity related to isolated (separate) vugs may contribute little to permeability, and the permeability may be controlled by the amount of interparticle pore space of the matrix. Thus, characterizing the different pore spaces in complex reservoirs can be a challenge.

Due to the coarse resolution of conventional porosity logs (e.g., such as some density, neutron, and sonic logs), differentiation between the types of porosity may be difficult, and both types of porosity may be under-estimated and/or overlooked. The accuracy of the evaluation of complex reservoirs has improved since the introduction of borehole image logging and subsequent interpretation workflows. One such implementation regards a method to analyze image texture by delineating conductive and resistive heterogeneities. Such implementation, however, may suffer shortcomings attributable to heterogeneities that are larger than the image pad width that are not detectable (in the case of pad imaging tools), the limited classification of heterogeneities, and the lack of one or more links to one or more reservoir parameters.

### SUMMARY OF THE DISCLOSURE

The present disclosure introduces a method involving acquiring acoustic data from an inspected region of a borehole extending into a subterranean formation by utilizing a downhole tool conveyed within the borehole. The downhole tool is in communication with surface equipment disposed at a wellsite surface from which the borehole extends. The method further includes operating at least one of the downhole tool and the surface equipment to generate a histogram based on the acoustic data associated with the inspected region, normalizing the histogram, and calculating a vug index based on the normalized histogram and based on a threshold of the normalized histogram. A vug porosity quantity may be determined based on the calculated vug index.

The present disclosure also introduces a system including one or more processors and a non-transitory tangible computer-readable memory coupled to the one or more processors having executable computer code stored in the memory. The code may include a set of instructions that causes the one or more processors to acquire acoustic data from a zone, generate an acoustic amplitude histogram based on amplitudes of the acoustic data, and calculate a vug index based on the acoustic amplitude histogram and a threshold of the acoustic amplitude histogram. The system may output the vug porosity of the zone based on the vug index and a total porosity of the zone.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flow-chart diagram of at least a portion of a method according to one or more aspects of the present disclosure.

FIG. 2 are acoustic amplitude histograms corresponding from acoustic image logs according to one or more aspects of the present disclosure.

FIG. 3 is a schematic view of at least a portion of apparatus according to one or more aspects of the present disclosure.

FIG. 4 is a block diagram of at least a portion of apparatus according to one or more aspects of the present disclosure.

### DETAILED DESCRIPTION

One or more specific embodiments of the present disclosure will be described below. These described embodiments are examples of the presently disclosed techniques. Additionally, in an effort to provide a concise description of these embodiments, certain features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it may be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Borehole electrical images have been developed in the industry to analyze carbonate porosity systems. Using such microresistivity images, vugs present at the surface of a borehole may be quantified in terms of proportion, size, and connectedness, etc. Suitable software may estimate the percentage of vugs present at the surface of the borehole image to analyze these vug properties, and the vug porosity curve may then be used to estimate permeability. Such methodologies may be useful for electrical images logged in water based mud systems. However, using the same techniques for quantifying vug porosity in oil or synthetic based muds may be more challenging.

The present techniques involve analyzing and/or quantifying vug porosity using acoustic images, which may have reduced sensitivity to the conductiveness of drilling fluids. Embodiments include using acoustic images to determine open or closed fractures. The techniques involve extracting histograms of acoustic amplitudes from acoustic images shown in high values which represent the average acoustic amplitudes of the matrix of the volume being investigated. The low amplitudes may correspond to low acoustic material such as volcanic debris, clays, or fluid-filled vugs while high amplitudes may correspond to features in the matrix. In homogenous carbonates, the amplitude distribution may show a unimodal distribution. In heterogeneous carbonates having a second porosity component, the amplitude distribution may show a bimodal histogram distribution.

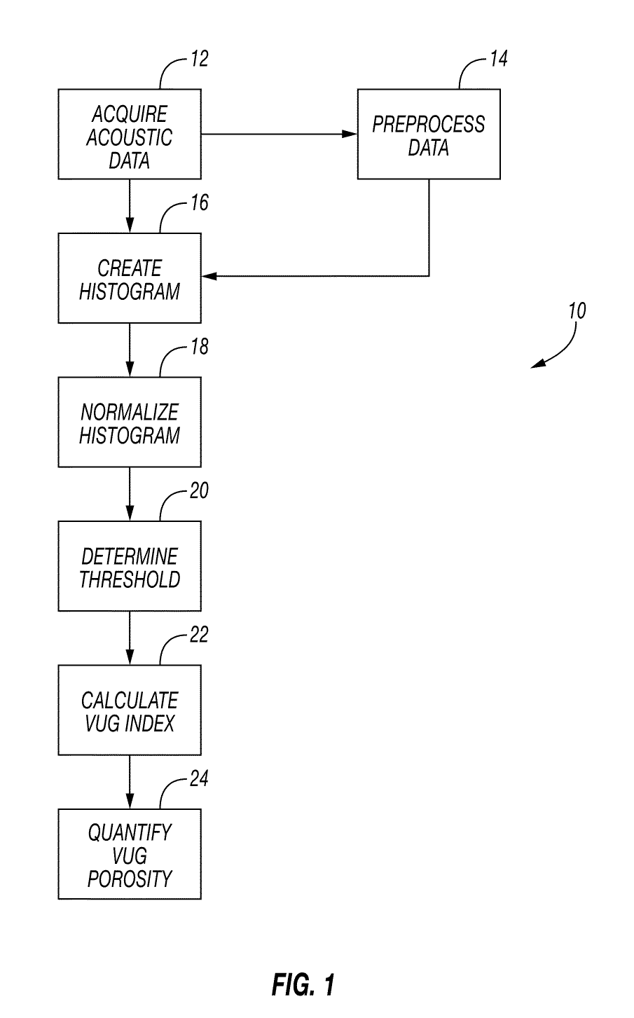

The present disclosure introduces a method or workflow 10 comprising a grouping of several intertwined processes, as depicted in FIG. 1. One or more aspects of the workflow 10 may improve vug porosity quantification within the scope of the present disclosure. The workflow 10 may incorporate raw acquisition data of a borehole image from wireline and/or while-drilling tools, and may be applicable or readily adapted for utilization with many properties of borehole images.

The workflow 10 may include acquiring (block 12) acoustic data. For example, the acoustic data may be acquired from an acoustic tool suitable for acquiring acoustic data from a borehole. The acoustic data may include log data or raw image data. Acoustic data may include ultrasonic data or sonic data from which acoustic (e.g., ultrasonic, sonic, etc.) amplitudes may be determined. In some embodiments, the workflow 10 may include preprocessing (block 14) the acoustic data to filter or fix erratic data values, match image depth, calibrate data, among other preprocessing possibilities within the scope of the present disclosure. The process may then involve creating or generating (block 16) an amplitude histogram based on the acoustic amplitude data. In some embodiments, generating an amplitude histogram based on acoustic amplitudes may involve identifying a bimodal histogram distribution or a unimodal distribution.

In some embodiments, the histogram may be normalized (block 18). For example, normalizing the histogram may include estimating a probability density function of the acoustic data, such that the amplitude histogram is normalized into a unit area. The workflow 10 may then involve determining (block 20) a threshold of the normalized histogram. In some embodiments, various techniques may be employed to determine a threshold of the normalized amplitude histogram. For example, determined using a linear discriminant analysis, a pattern recognition and statistical analysis, or another suitable technique. In some embodiments, obtaining (block 20) the threshold may result in distinguishing acoustic amplitudes associated with host material from acoustic amplitudes associated with vugs or macropores. Threshold determination may also involve obtaining the threshold for bimodal amplitude distribution by using selecting a discriminant threshold (e.g., using a script in software). Furthermore, the threshold may be different depending on the histogram. For example, throughout various depths of an acoustic log, the acoustic amplitude histogram at each depth may vary, which may result in determining a different threshold. Moreover, when the workflow 10 is applied through various depths of acoustic log data, a different threshold may be determined at each depth, depending on the histogram generated at a particular depth.

A vug index may be calculated (block 22) by distinguishing primary, secondary, or other types of porosity based on where acoustic amplitudes fall with respect to the threshold. In some embodiments, the percentage of the vug porosity may be calculated (block 20) in terms of a ratio or a vug index of a number of acoustic amplitudes associated with vugs or macropores. For example, at a particular depth in an acoustic log, a number of samples (e.g., 180 samples, each sample taken at every 2 degrees of the full borehole image) of acoustic amplitudes may be taken. The acoustic amplitude of each sample may be either below the threshold, indicating vugs or macropores, or above the threshold, indicating the matrix or host. The vug index may be calculated (block 22) by taking the number of samples having an acoustic amplitude below the threshold and dividing this number by the total number of samples (e.g., 180). The resulting vug index may be used to quantify (block 24) vug porosity. In some embodiments, the vug index may be multiplied by a total porosity at that depth. For example, the vug index at a particular depth may be multiplied by a porosity at a corresponding depth of the borehole in a total porosity log, resulting in the vug porosity at that depth of the borehole.

The workflow 10 depicted in FIG. 1 may also be performed in an order other than as shown in FIG. 1. Steps in the workflow 10 may also occur substantially simultaneously. Furthermore, other implementations of the order of activities performed in the workflow 10 are also within the scope of the present disclosure.

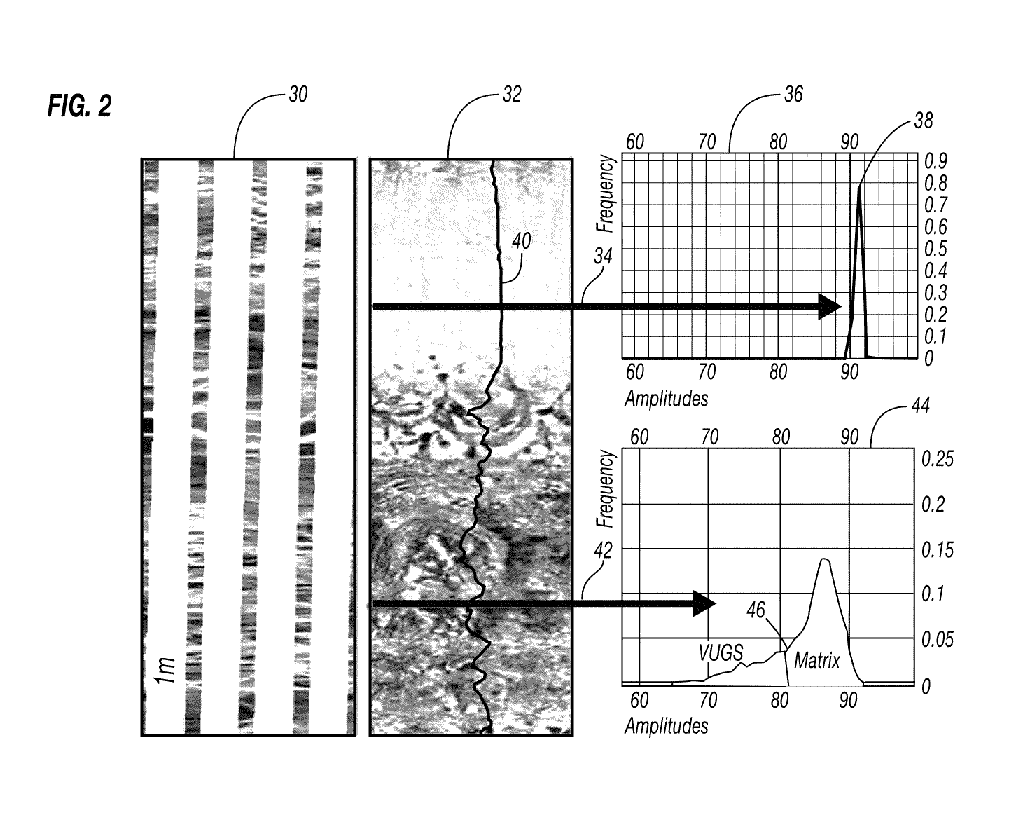

FIG. 2 shows electrical and acoustic image logs in a carbonate formation and corresponding histograms extracted at two different depths. In some situations, due to the pad coverage of an electrical image log 30 taken in oil based mud, not all features may be logged or imaged. The ultrasonic image log 32 displayed in FIG. 2 shows a greater degree of borehole coverage, but in heterogeneous carbonates having a second porosity component, it may be difficult to distinguish between the primary porosity and the secondary porosity. The amplitude distribution may show a bimodal histogram distribution where facies are texturally heterogeneous.

For example, at depth 34, the ultrasonic image 32 may have texturally homogenous facies. A corresponding acoustic amplitude histogram 36 may have a relatively unimodal distribution, and a peak 38 in the amplitude histogram 36 may correspond relatively clearly with a feature 40 associated with the matrix and the vugs of the volume logged in the ultrasonic image log 32. At depth 42, the ultrasonic image 32 may have been logged from an area having a high degree of second porosity from which it may be difficult to separate primary porosity from secondary porosity, or respectively, the matrix from the vugs. The corresponding amplitude histogram 44 may be relatively bimodal, and the matrix may be distinguished from the vugs based on a threshold 46.

In some embodiments, vug porosity may be quantified based on the acoustic amplitude histograms through combinations of computations including the breakout and background removal, normalization of acoustic amplitude histograms, determination of an amplitude threshold that distinguishes host acoustic amplitude of the matrix from the lowest acoustic amplitudes for vugs and macropores, and calibration with the total porosity log. In some embodiments, calibration with the porosity log may be derived from a density-neutron log crossplot porosity or other log analyses methods.

For example, and with respect to FIG. 1, a vug index may be calculated (block 22) based on the acoustic amplitude histogram 44 created (block 16) from the depth 42 of the acoustic log data 32. Based on the threshold 46 determined (block 20) from, for example, a linear discriminant analysis, a pattern recognition, statistical analysis, or any other suitable technique or combinations of such techniques, the workflow 10 may calculate (block 22) the vug index by counting the number of acoustic amplitude samples falling below the threshold 46. For example, if 30 samples have acoustic amplitudes falling below the threshold 46 in histogram 44, then the vug index may be 30/180 (assuming 180 total samples, in some embodiments), resulting in a vug index of 1/6. To quantify (block 24) the vug porosity at depth 42, the vug index may then be multiplied by a total porosity at a depth corresponding to depth 42 of the acoustic log. For example, a total porosity log may be used, and the total porosity at the depth and/or zone of interest corresponding to depth 42 of the acoustic log 32 may be multiplied by the calculated vug index of 1/6 to quantify the vug porosity at that depth.

The vug porosity computation may be implemented in software. For example, a suitable software may include Schlumberger's Techlog Wellbore Software Platform. The creation of the amplitude histogram may involve displaying the amplitudes over a sliding window having user-defined parameters (e.g., a window of 1.2 inches within 100 bins). Data may be stacked or not stacked, and histograms may be computed for intervals of 0.2 inches. Creating the histogram may be performed by a suitable software.

Vug porosity determined based on the acoustic contrast of the formation measured by an ultrasonic imager may be a log curve having a relatively high vertical resolution curve and may more clearly capture the variation of porosity of the carbonate formations than the conventional logs. In some embodiments, vug porosity may be used to calibrate and validate the volume of macropores derived from NMR or to construct a robust reservoir rock classification scheme when combined with conventional logs and lithofacies.

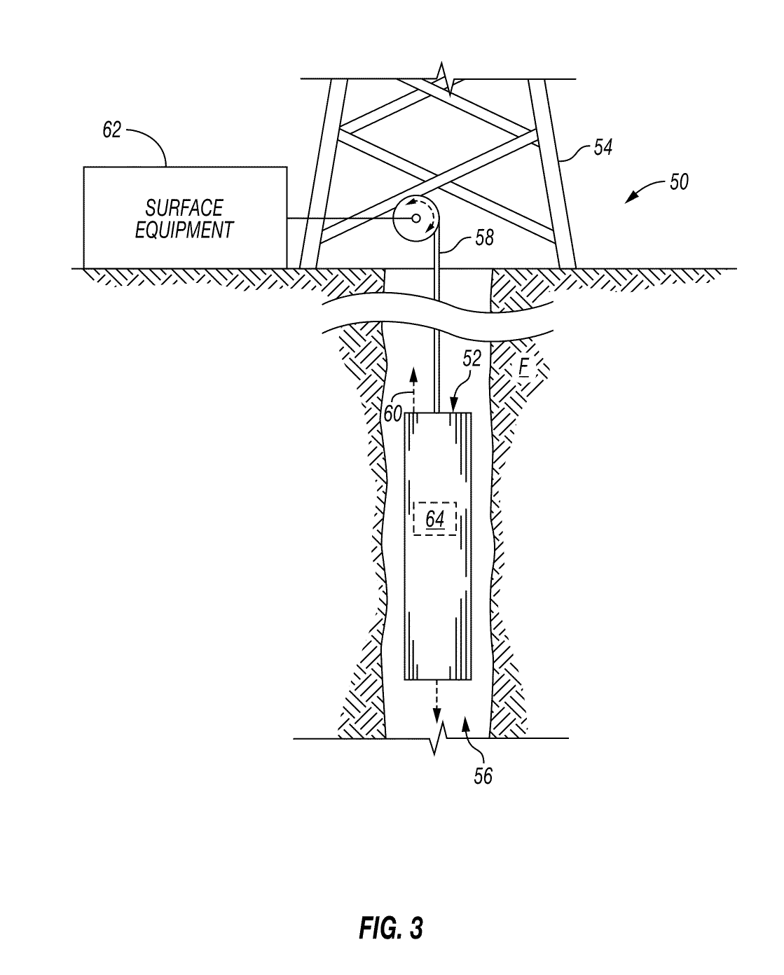

FIG. 3 is a schematic view of an example imaging system 50 that may be employed onshore and/or offshore according to one or more aspects of the present disclosure, representing an example environment in which one or more aspects described above may be implemented. As depicted in FIG. 3, a downhole tool 52 may be suspended from a rig 54 in a borehole 56 formed in one or more subterranean formations F. The downhole tool 52 may be or comprise an acoustic tool, a conveyance tool, a density tool, an electromagnetic (EM) tool, a formation evaluation tool, a magnetic resonance tool, a monitoring tool, a neutron tool, a nuclear tool, a photoelectric factor tool, a porosity tool, a reservoir characterization tool, a resistivity tool, a seismic tool, a surveying tool, and/or a telemetry tool, although other downhole tools are also within the scope of the present disclosure.

The downhole tool 52 may be deployed from the rig 54 into the borehole 56 via a conveyance means 58, which may be or comprise a wireline cable, a slickline cable, and/or coiled tubing, although other means for conveying the downhole tool 52 within the borehole 56 are also within the scope of the present disclosure. As the downhole tool 52 operates, outputs of various numbers and/or types from the downhole tool 52 and/or components thereof (one of which is designated by reference numeral 60) may be sent via, for example, telemetry to a logging and control system and/or other surface equipment 62 at surface, and/or may be stored in various numbers and/or types of memory for subsequent recall and/or processing (e.g., in the processing and/or memory unit 64) after the downhole tool 52 is retrieved to surface. The downhole tool 52 and/or one or more components 62 thereof may be utilized to perform at least a portion of the techniques for quantifying vug porosity based on acoustic amplitude data, according to one or more aspects of the present disclosure.

Furthermore, in some embodiments, a suitable downhole tool 52 for acquiring the acoustic data may be a directional drilling tool, a drilling tool, a logging while drilling (LWD) tool, a measurement while drilling (MWD) tool, although other downhole tools are also within the scope of the present disclosure.

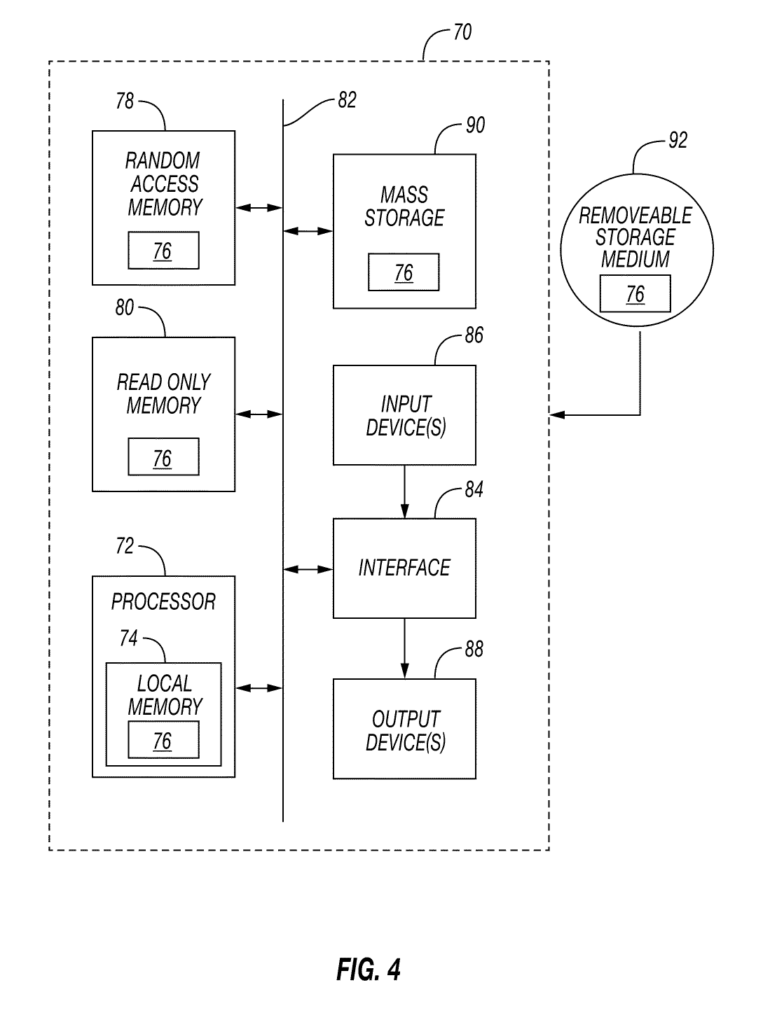

FIG. 4 is a block diagram of an example processing system 70 that may execute example machine-readable instructions used to implement one or more of the methods and/or processes described herein, and/or to implement the example downhole tools described herein. The processing system 70 may be at least partially implemented in a downhole tool 52 and/or components 64 and/or in one or more surface equipment components 62 shown in FIG. 3, and/or in some combination thereof. The processing system 70 may be or comprise, for example, one or more processors, one or more controllers, one or more special-purpose computing devices, one or more servers, one or more personal computers, one or more personal digital assistant (PDA) devices, one or more smartphones, one or more internet appliances, and/or any other type(s) of computing device(s).

The system 70 comprises a processor 72 such as, for example, a general-purpose programmable processor. The processor 72 includes a local memory 74, and executes coded instructions 76 present in the local memory 74 and/or in another memory device. The processor 72 may execute, among other things, machine-readable instructions to implement the methods and/or processes described herein. The processor 72 may be, comprise or be implemented by any type of processing unit, such as one or more INTEL microprocessors, one or more microcontrollers from the ARM and/or PICO families of microcontrollers, one or more embedded soft/hard processors in one or more FPGAs, etc. Of course, other processors from other families are also appropriate.

The processor 72 is in communication with a main memory including a volatile (e.g., random access) memory 78 and a non-volatile (e.g., read-only) memory 80 via a bus 82. The volatile memory 78 may be, comprise, or be implemented by static random access memory (SRAM), synchronous dynamic random access memory (SDRAM), dynamic random access memory (DRAM), RAMBUS dynamic random access memory (RDRAM) and/or any other type of random access memory device. The non-volatile memory 80 may be, comprise, or be implemented by flash memory and/or any other desired type of memory device. One or more memory controllers (not shown) may control access to the main memory 78 and/or 80.

The processing system 70 also includes an interface circuit 84. The interface circuit 84 may be, comprise, or be implemented by any type of interface standard, such as an Ethernet interface, a universal serial bus (USB) and/or a third generation input/output (3GIO) interface, among others.

One or more input devices 86 are connected to the interface circuit 84. The input device(s) 86 permit a user to enter data and commands into the processor 72. The input device(s) may be, comprise or be implemented by, for example, a keyboard, a mouse, a touchscreen, a track-pad, a trackball, an isopoint and/or a voice recognition system, among others.

One or more output devices 88 are also connected to the interface circuit 84. The output devices 88 may be, comprise, or be implemented by, for example, display devices (e.g., a liquid crystal display or cathode ray tube display (CRT), among others), printers and/or speakers, among others. Thus, the interface circuit 84 may also comprise a graphics driver card.

The interface circuit 84 also includes a communication device such as a modem or network interface card to facilitate exchange of data with external computers via a network (e.g., Ethernet connection, digital subscriber line (DSL), telephone line, coaxial cable, cellular telephone system, satellite, etc.).

The processing system 70 also includes one or more mass storage devices 90 for storing machine-readable instructions and data. Examples of such mass storage devices 90 include floppy disk drives, hard drive disks, compact disk drives and digital versatile disk (DVD) drives, among others.

The coded instructions 76 may be stored in the mass storage device 90, the volatile memory 78, the non-volatile memory 80, the local memory 76 and/or on a removable storage medium, such as a CD or DVD 92.

Instead of implementing the methods and/or apparatus described herein in a system such as the processing system of FIG. 4, the methods and or apparatus described herein may be embedded in a structure such as a processor and/or an ASIC (application specific integrated circuit).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same intents and/or achieving the same aspects introduced herein. Those skilled in the art should also realize that such equivalent constructions do not depart from the spirit and scope of the present disclosure, and that they may make various changes, substitutions and alterations herein without departing from the spirit and scope of the present disclosure. For example, although the preceding description has been described herein with reference to particular means, materials and embodiments, it is not intended to be limited to the particulars disclosed herein; rather, it extends to functionally equivalent structures, methods, and uses, such as are within the scope of the appended claims.

The Abstract at the end of this disclosure is provided to comply with 37 C.F.R. §1.72(b) to permit the reader to quickly ascertain the nature of the technical disclosure. It is submitted with the understanding that it will not be used to interpret or limit the scope or meaning of the claims.

What is claimed is:

1. A method, comprising:
acquiring acoustic data from an inspected region of a borehole extending into a subterranean formation by utilizing a downhole tool conveyed within the borehole, wherein the downhole tool is in communication with surface equipment disposed at a wellsite surface from which the borehole extends; and
operating at least one of the downhole tool and the surface equipment to:
generate a histogram based on the acoustic data associated with the inspected region;
normalize the histogram;
calculate a vug index based on the normalized histogram and based on a threshold of the normalized histogram; and
determine a vug porosity quantity of the inspected region based on the calculated vug index.

2. The method of claim 1 wherein determining the vug porosity quantity of the inspected region is further based on a porosity of the inspected region.

3. The method of claim 2, wherein determining the vug porosity quantity comprises multiplying the vug index of the inspected region by the porosity of the inspected region.

4. The method of claim 1, wherein calculating the vug index comprises dividing a number of vug samples by a number of total samples, wherein vug samples comprise samples of acoustic data having amplitudes below the threshold and total samples comprise a total number of samples of acoustic data acquired in the inspected region.

5. The method of claim 1 wherein normalizing the histogram comprises estimating a probability density function of the acoustic data.

6. The method of claim 1 comprising determining the threshold using a linear discriminant analysis, pattern recognition and statistical analysis, or combinations thereof.

7. The method of claim 1 wherein generating the histogram, normalizing the histogram, calculating the vug index, and determining the vug porosity are each performed at a plurality of inspected regions, each corresponding to one of a plurality depths in the borehole.

8. The method of claim 1 wherein generating the histogram comprises plotting a frequency of acoustic amplitudes of the acoustic data.

9. The method of claim 1 wherein generating the histogram comprises identifying a bimodal histogram distribution, unimodal histogram distribution, or combinations thereof.

10. The method of claim 1 comprising distinguishing acoustic amplitudes associated with a host material from acoustic amplitudes associated with vugs or macropores.

11. The method of claim 1, wherein acquiring acoustic data comprises acquiring ultrasonic data from a downhole tool suitable for logging ultrasonic measurements, and wherein operating at least one of the downhole tool and the surface equipment comprises generating the histogram based on the ultrasonic data.

12. A system comprising:
one or more processors;
a non-transitory tangible computer-readable memory coupled to the one or more processors having executable computer code stored thereon, the code comprising a set of instructions that causes the one or more processors to perform the following:
acquire acoustic data from a zone;
generate an acoustic amplitude histogram based on amplitudes of the acoustic data;
calculate a vug index based on the acoustic amplitude histogram and a threshold of the acoustic amplitude histogram; and
output a vug porosity of the zone based on the vug index and a total porosity of the zone.

13. The system of claim 12 wherein the non-transitory tangible computer-readable memory further comprises instructions to cause the one or more processors to normalize the acoustic amplitude histogram by estimating a probability density function of the acoustic data.

14. The system of claim 12 wherein the non-transitory tangible computer-readable memory further comprises instructions to cause the one or more processors to determine the threshold using a linear discriminant analysis, pattern recognition and statistical analysis, or combinations thereof.

15. The system of claim 12, wherein the non-transitory tangible computer-readable memory comprises instructions to calculate the vug index by dividing a number of vug samples by a number of total samples, wherein vug samples comprise samples of acoustic data having amplitudes below the threshold and total samples comprise a total number of samples of acoustic data acquired in the zone.

16. The system of claim 12 wherein the non-transitory tangible computer-readable memory further comprises instructions to cause the one or more processors to identify a bimodal histogram distribution, unimodal histogram distribution, or combinations thereof from the acoustic amplitude histogram.

17. The system of claim 12 wherein the non-transitory tangible computer-readable memory further comprises instructions to cause the one or more processors to distinguish between matrix acoustic amplitudes of the acoustic data associated with a host material and vug acoustic amplitudes of the acoustic data associated with vugs or macropores.

18. The system of claim 12, comprising an acoustic downhole tool conveyable in a borehole and suitable for acquiring acoustic data from one or more zones of a formation of the borehole, and wherein a portion of the one or more processors operates from the acoustic downhole tool.

19. The system of claim 18, wherein the non-transitory tangible computer-readable memory further comprises instructions to cause the one or more processors to determine a different threshold for each acoustic amplitude histogram generated from acoustic data acquired from different zones of the one or more zones of the formation.

20. The system of claim 1, wherein the acoustic downhole tool is an ultrasonic downhole tool suitable for acquiring ultrasonic data, and wherein the non-transitory tangible computer-readable memory is suitable for causing the one or more processors to perform the set of instructions on the ultrasonic data.
